(19) United States
(12) Patent Application Publication
(10) Pub. No.: US 2022/0135790 A1
(43) Pub. Date: May 5, 2022

(54) COMPOSITIONS HAVING IMPROVED CHEMICAL RESISTANCE, ARTICLES FORMED THEREOF, AND METHODS OF MANUFACTURE

(71) Applicant: SHPP GLOBAL TECHNOLOGIES B.V., Bergen op Zoom (NL)

(72) Inventors: Alexander VAN GOUDSWAARD, Bergen op Zoom (NL); Johannes DE BROUWER, Bergen op Zoom (NL)

(21) Appl. No.: 17/434,178

(22) PCT Filed: Mar. 2, 2020
(86) PCT No.: PCT/IB2020/051751

§ 371 Date: Aug. 26, 2021

(30) Foreign Application Priority Data
Mar. 1, 2019 (EP) 19160335.6

(51) Int. Cl. C08L 67/02

(52) U.S. Cl. CPC C08L 67/02; C08L 2205/035

(57) ABSTRACT

A thermoplastic composition includes 40 to 70 wt % of a polyester; 5 to 50 wt % of a poly(carbonate-siloxane), a poly(carbonate-siloxane-arylate), or a combination thereof; and 0.1 to 8 wt % of an additive comprising a processing aid, a heat stabilizer, an antioxidant, an ultra violet light absorber, or a combination thereof. An ASTM tensile bar comprising the composition has a tensile strength retention of at least 90% and a tensile elongation at break retention of at least 80% after exposure of the bar for 7 days to SANI-CLOTH AF3 at a temperature of 23° C. under 1% strain compared to a non-exposed reference tested at the same temperature. An article comprising the thermoplastic composition is also described.

### CROSS-REFERENCE TO RELATED APPLICATION

This application claims priority to and the benefit of EP Application No. 19160335.6, filed Mar. 1, 2019, the contents of which are incorporated herein by reference in their entirety.

### BACKGROUND

In the healthcare industry, medical devices are frequently placed in contact with liquids. For example, medical devices can be disinfected through washing with liquid disinfecting agents. Some liquids degrade the materials the medical devices are formed from. This can reduce the useable life of the devices. New compositions are needed to address these shortcomings. Added advantage comes from materials that can also provide desirable mechanical and/or flame-resistance.

### SUMMARY

Novel thermoplastic compositions having excellent chemical resistance are disclosed. The compositions can be used to manufacture medical devices that have increased useful life, even when subjected to frequent cleaning or disinfecting. The thermoplastic compositions comprise, based on the total weight of the thermoplastic compositions: 40 to 70 wt % of a polyester; 5 to 50 wt % of a poly(carbonate-siloxane), a poly(carbonate-siloxane-arylate), or a combination thereof; and 0.1 to 8 wt % of an additive comprising a processing aid, a heat stabilizer, an antioxidant, an ultra violet light absorber, or a combination thereof. An ASTM tensile bar comprising the compositions has a tensile strength retention of at least 90% after exposure of the bar for 7 days to SANI-CLOTH AF3 at a temperature of 23° C. under 1% strain compared to a non-exposed reference tested at the same temperature, and a tensile elongation at break retention of at least 80% after exposure of the bar for 7 days to SANI-CLOTH AF3 at a temperature of 23° C. under 1% strain compared to a non-exposed reference tested at the same temperature. Articles comprising the above described thermoplastic compositions are also described, the tensile strength retention and tensile elongation at break retention are measured according to ASTM D 638 and compared to the non-exposed reference.

The above described and other features are exemplified by the following Detailed Description and Examples.

### DETAILED DESCRIPTION

Thermoplastic compositions having improved chemical resistance towards aggressive disinfectants such as SANI-CLOTH AF3 and SANI-CLOTH PLUS can be unexpectedly obtained by combining a polyester with a poly(carbonate-siloxane), a poly(carbonate-siloxane-arylate), or a combination thereof. Advantageously, these compositions also have one or more of good processability, good flame-retardant properties, and balanced mechanical properties. Thermoplastic compositions can advantageously be used to make articles in healthcare applications.

The polyester in the thermoplastic compositions can comprise units of formula (1):

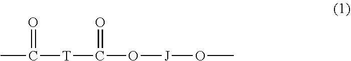

wherein J is a divalent group derived from a dihydroxy compound (including a reactive derivative thereof), and can be, for example, a C₁₋₁₀ alkylene, a C₆₋₂₀ cycloalkylene, a C₅₋₂₀ arylene, or a poly(oxyalkylene) in which the alkylene groups contain 2 to 6 carbon atoms, specifically 2, 3, or 4 carbon atoms; and T is a divalent group derived from a dicarboxylic acid (including a reactive derivative thereof), and can be, for example, a C₂₋₂₀ alkylene, a C₅₋₂₀ cycloalkylene, or a C₆₋₂₀ arylene. Copolyesters containing a combination of different T or J groups can be used.

Specific dihydroxy compounds can be used to prepare the polyesters such as C₁₋₈ aliphatic diols such as ethane diol, n-propane diol, iso-propane diol, 1,4-butane diol, 1,4-cyclohexane diol, 1,4-hydroxymethylcyclohexane; aromatic dihydroxy compounds such as resorcinol, hydroquinone, bisphenol A, or a combination thereof. Aliphatic dicarboxylic acids that can be used to prepare the polyesters include C₅₋₂₀ aliphatic dicarboxylic acids (which includes the terminal carboxyl groups), preferably C₈₋₁₂ aliphatic dicarboxylic acid such as decanedioic acid (sebacic acid); 1,4-cyclohexane dicarboxylic acid; and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, or a combination thereof.

Specific polyesters can include poly(ethylene terephthalate) (PET), poly(1,4-butylene terephthalate) (PBT), poly(n-propylene terephthalate) (PPT), poly(alkylene naphthoates), poly(butylene naphthanoate) (PBN), poly(1,4-cyclohexanedimethylene terephthalate) (PCT). Combinations comprising at least one of the foregoing polyesters can also be used.

Copolymers comprising alkylene terephthalate repeating ester units with other ester groups can also be useful. Copolymers of this type include poly(ethylene terephthalate)-co-(1,4-cyclohexanedimethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Polyesters can also include poly(alkylene cyclohexane dicarboxylate)s. Of these, a specific example is poly(1,4-cyclohexane-dimethanol-1,4-cyclohexane dicarboxylate) (PCCD), having recurring units of formula (2):

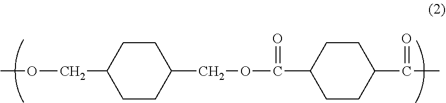

wherein, as described using formula (1), J is a 1,4-cyclohexanedimethylene group derived from 1,4-cyclohexanedimethanol, and T is a cyclohexane ring derived from cyclohexane dicarboxylate or a chemical equivalent thereof, and can comprise the cis-isomer, the trans-isomer, or a combination thereof.

The polyester can be poly(1,4-butylene terephthalate) (PBT). The PBT can have a weight average molecular weight (Mw) of 10,000 to 150,000 Daltons (Da), and preferably from 40,000 to 110,000 Da, as measured by gel permeation chromatography using a crosslinked styrene-divinyl benzene column, and as calibrated with polystyrene standards.

More than one polyester can be present. Thermoplastic compositions can comprise a first PBT with an intrinsic viscosity of 1 to 1.5 deciliter/gram (dl/g) as measured in a 60:40 phenol/tetrachloroethane mixture; and a second PBT with an intrinsic viscosity of 0.9 to 0.3 dl/g as measured in a 60:40 phenol/tetrachloroethane mixture. The first polyester can have an intrinsic viscosity of 1.1-1.2 dl/g, and a carboxylic acid (COOH) end group content of 38 meq/Kg COOH. Such a first polyester is commercially available under the trade name VALOX 315 from SABIC. The second PBT can have an intrinsic viscosity of 0.66 dl/g, and a carboxylic acid (COOH) end group content of 17 meq/Kg COOH and is commercially available under the tradename VALOX 195 from SABIC. The weight ratio of the first PBT relative to the second PBT can be 10:1 to 2:1, or 8:1 to 4:1, or 7:1 to 5:1.

The polyester can be present in the thermoplastic compositions in an amount of 40 to 70 wt %, based on the total weight of the thermoplastic compositions. When the thermoplastic compositions comprise a poly(carbonate-siloxane), the polyester can be present in an amount of 40 to 60 wt % or 45 to 55 wt %; and when the thermoplastic compositions comprise a poly(carbonate-siloxane) and a flame retardant, the polyester can be present in an amount of 50 to 70 wt % or 55 to 65 wt %, each based on the total weight of the thermoplastic compositions. When the thermoplastic compositions comprise a poly(carbonate-siloxane-arylate), the polyester can be present in an amount of 30 to 50 wt % or 35 to 45 wt %; and when the thermoplastic compositions comprise a poly(carbonate-siloxane-arylate) and a flame retardant, the polyester can be present in an amount of 5 to 35 wt % or 10 to 30 wt %, each based on the total weight of the thermoplastic compositions.

The poly(carbonate-siloxane) component in the thermoplastic compositions is also known as a poly(carbonate-siloxane). The poly(carbonate-siloxane) comprises carbonate units and siloxane units. The carbonate units are of formula (3):

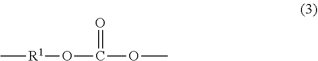

wherein at least 60 percent of the total number of R¹ groups are aromatic, or each R¹ contains at least one C₆₋₃₀ aromatic group. A combination of different R¹ groups can be present. The carbonate units can be derived from a dihydroxy aromatic compound such as a bisphenol of formula (4) or a diphenol of formula (5):

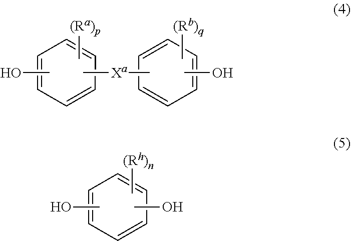

wherein in formula (4) R^{a} and R^{b} are each independently C₁₋₁₂ alkyl, C₂₋₁₂ alkenyl, C₃₋₈ cycloalkyl, or C₁₋₁₂ alkoxy, p and q are each independently 0 to 4, and X^{a} is a single bond, —O—, —S—, —S(O)—, —S(O)₂—, —C(O)—, a C₁₋₁₁ alkylidene of formula —C(R^{c})(R^{d})— wherein R^{c} and R^{d} are each independently hydrogen or C₁₋₁₀ alkyl, or a group of the formula —C(═R^{e})— wherein R^{e} is a divalent C₁₋₁₀ hydrocarbon group; and in formula (5), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In an aspect in formulas (4) and (5), R^{a} and R^{b} are each independently C₁₋₃ alkyl or C₁₋₃ alkoxy, p and q are each independently 0 to 1, and X^{a} is a single bond, —O—, —S(O)—, —S(O)₂—, —C(O)—, a C₁₋₁₁ alkylidene of formula —C(R^{c})(R^{d})— wherein R^{c} and R^{d} are each independently hydrogen or C₁₋₁₀ alkyl, each R^{h} is independently bromine, a C₁₋₃ alkyl, a halogen-substituted C₁₋₃ alkyl, and n is 0 to 1.

Some illustrative examples of dihydroxy compounds (4) that can be used are described, for example, in WO 2013/175448 A1, US 2014/0295363, and WO 2014/072923. Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane, and 1,1-bis(4-hydroxyphenyl)-3,3,5-trimethylcyclohexane (isophorone bisphenol). Examples of diphenol compounds (5) included resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like. A combination of different diphenol compounds can be used.

In preferred embodiments, the carbonate units are of formula (3a):

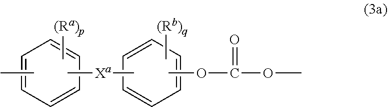

wherein R^{a}, R^{b}, X^{a}, p, and q are the same as those defined in formula (4). In an aspect of formula (3a), R^{a} and R^{b} are each independently C₁₋₆ alkyl or C₁₋₃ alkoxy, p and q are each independently 0 to 1, and X^{a} is a single bond, —O—, —S(O)—, —S(O)₂—, —C(O)—, a C₁₋₁₁ alkylidene of formula —C(R^{c})(R^{d})— wherein R^{c} and R^{d} are each independently hydrogen or C₁₋₁₀ alkyl. Preferably, the carbonate units (3a) are derived from BPA, 3,3-bis(4-hydroxyphenyl) phthalimidine, 1,1-bis(4-hydroxy-3-methylphenyl)cyclohexane, or 1,1-bis(4-hydroxyphenyl)-3,3,5-trimethylcyclohexane (isophorone), or a combination thereof. More preferably, the carbonate units are bisphenol A carbonate units having the formula (3b):

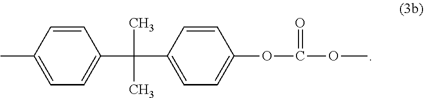

The siloxane units (also referred to as polysiloxane blocks) are of formula (6):

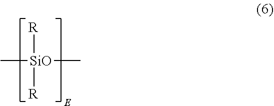

wherein each R is independently a C₁₋₁₃ monovalent organic group. For example, R can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylarylenoxy. The foregoing groups can be fully or partially halogenated with fluorine, chlorine, bromine, or iodine, or a combination thereof. Combinations of the foregoing R groups can be used in the same copolymer.

In an aspect, R is a C₁₋₃ alkyl, C₁₋₃ alkoxy, C₃₋₆ cycloalkyl, C₃₋₆ cycloalkoxy, C₆₋₁₄ aryl, C₆₋₁₀ aryloxy, C₇ arylalkylene, C₇ arylalkylenoxy, C₇ alkylarylene, or C₇ alkylarylenoxy. In still another embodiment, R is methyl, trifluoromethyl, or phenyl.

The value of E in formula (6) can vary widely depending on the type and relative amount of each component in the thermoplastic compositions, the desired properties of the composition, and like considerations. Generally, E has an average value of 2 to 125, 5 to 80, or 10 to 100. Preferably, E has an average value of 20 to 60, or 30 to 50, or 40 to 50.

In an aspect, the siloxane units are of formula (7):

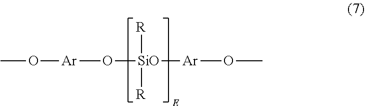

wherein E is as defined in formula (6); each R can be the same or different and is as defined above in the context of formula (6); and Ar can be the same or different and is a substituted or unsubstituted C₆₋₃₀ arylene, wherein the bonds are directly connected to an aromatic moiety. Ar groups in formula (7) can be derived from a C₆₋₃₀ dihydroxyarylene compound, for example a dihydroxy compound of formula (4). Exemplary dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane. Combinations comprising at least one of the foregoing dihydroxy compounds can also be used.

Specific examples of siloxane units of formula (7) include those of the formulas (7a) and (7b):

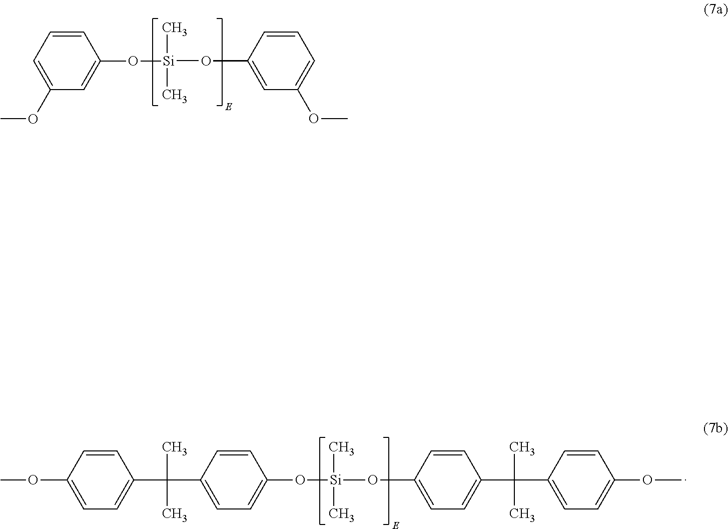

In another embodiment, the siloxane units are of formula (8):

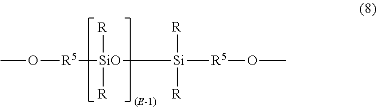

wherein R and E are as described in formula (6), and each R⁵ is independently a divalent C₁-C₃₀ organic group, and wherein the polymerized polysiloxane unit is the reaction residue of its corresponding dihydroxy compound. In a specific embodiment, the siloxane units are of formula (9):

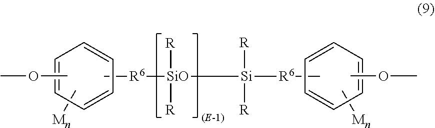

wherein R and E are as defined above in the context of formula (6). R⁶ in formula (9) is a divalent C₂₋₈ aliphatic. Each M in formula (9) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ arylalkylenoxy, C₇₋₁₂ alkylarylene, or C₇₋₁₂ alkylarylenoxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, R is methyl, M is methoxy, n is one, and R⁶ is a divalent C₁₋₃ aliphatic group. Specific siloxane units are of the formula

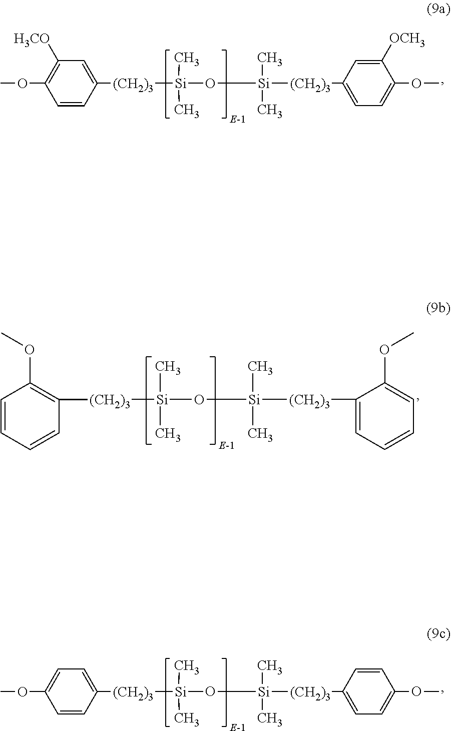

or a combination thereof, wherein E has an average value of 10 to 100, preferably 20 to 80, or 30 to 70, more preferably 30 to 50 or 40 to 50.

Siloxane units of formula (9) can be derived from the corresponding dihydroxy polydiorganosiloxane of formula (10),

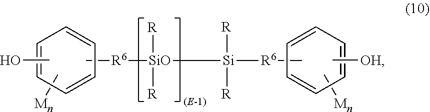

which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol.

The poly(carbonate-siloxane) can be manufactured by introducing phosgene under interfacial reaction conditions into a mixture of bisphenol and an end capped polydimethylsiloxane. Other known methods can also be used.

In an aspect, the poly(carbonate-siloxane) comprises carbonate units derived from bisphenol A, and repeating siloxane units (7a), (7b), (9a), (9b), (9c), or a combination thereof (preferably of formula 9a), wherein E has an average value of E has an average value of 10 to 100, preferably 20 to 80, or 30 to 70, more preferably 30 to 50 or 40 to 50.

The poly(carbonate-siloxane) can have a siloxane content of 5 to 30 wt %, or 10 to 30 wt %, preferably 15 to 25 wt %, more preferably 17 to 23 wt %, each based on the total weight of the poly(carbonate-siloxane). As used herein, “siloxane content” of a poly(carbonate-siloxane) refers to the content of siloxane units based on the total weight of the poly(carbonate-siloxane). The poly(carbonate-siloxane) can have an Mw of 28,000 to 32,000 Da, preferably 29,000 to 31,000 Da as measured by gel permeation chromatography using a crosslinked styrene-divinyl benzene column, at a sample concentration of 1 milligram per milliliter, and as calibrated with bisphenol A polycarbonate standards.

The poly(carbonate-siloxane) can be present in an amount effective to provide 0.2 to 10 wt %, preferably 1 to 5 wt % of siloxane units, based on the total weight of the thermoplastic compositions.

In an aspect, the poly(carbonate-siloxane) can be present in the thermoplastic compositions in an amount of 5 to 50 wt %, 10 to 30 wt %, 30 to 50 wt %, or 35 to 45 wt %, based on the total weight of the thermoplastic compositions.

The poly(carbonate-siloxane-arylate) component in the thermoplastic compositions comprise carbonate units, siloxane units, and arylates. The carbonate units are as described herein in formulas (3), (3a), and (3b) or are derived from bisphenols of formulas (4) and (5). The siloxane units are as described herein in formulas (6), (7), (7a), (7b), (8), (9), (9a), (9b), and (9c), wherein E has an average value of 2 to 125, 5 to 125, 5 to 100, 5 to 50, 20 to 80, or 5 to 20.

The poly(carbonate-siloxane-arylate) further comprises arylate units, i.e., ester units based on an aromatic dicarboxylic acid repeating ester units of formula (11)

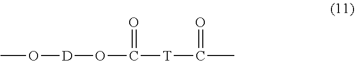

wherein D is a divalent group derived from a dihydroxy compound, and can be, for example, a C₆₋₂₀ alicyclic group or a C₆₋₂₀ aromatic group; and T is a divalent C₆₋₂₀ arylene group. In an aspect, D is derived from a dihydroxy aromatic compound of formula (4), formula (5) or a combination thereof. The D and T groups are desirably minimally substituted with hydrocarbon-containing substituents such as alkyl, alkoxy, or alkylene substituents. In an aspect, less than 5 mol %, preferably less than or equal to 2 mol %, and still more preferably less than or equal to 1 mol % of the combined number of moles of D and T groups are substituted with hydrocarbon-containing substituents such as alkyl, alkoxy, or alkylene substituents.

Examples of aromatic dicarboxylic acids from which the T group in the ester unit of formula (11) is derived include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or combinations thereof. A specific dicarboxylic acid comprises a combination of isophthalic acid and terephthalic acid wherein the weight ratio of isophthalic acid to terephthalic acid is 99:1 to 1:99.

In an aspect, the arylate units are derived from the reaction product of one equivalent of an isophthalic acid derivative and/or terephthalic acid derivative. In such an embodiment, the arylate units are of formula (11a):

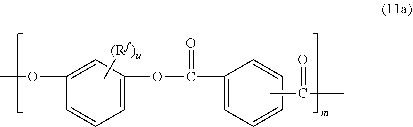

wherein each R^{f} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and u is 0 to 4, and m is greater than or equal to 4. In an aspect, m is 4 to 100, 4 to 50, preferably 5 to 30, more preferably 5 to 25, and still more preferably 10 to 20. In another embodiment, the molar ratio of isophthalate to terephthalate can be 0.25:1 to 4.0:1. Preferred arylate units are isophthalate-terephthalate-resorcinol ester units, isophthalate-terephthalate-bisphenol A ester units, or a combination of these, which can be referred to respectively as poly(isophthalate-terephthalate-resorcinol) ester units, poly(isophthalate-terephthalate-bisphenol-A) ester units, and poly[(isophthalate-terephthalate-resorcinol) ester-co-(isophthalate-terephthalate-bisphenol-A)] ester units.

In an aspect, the carbonate units and the ester units are present as blocks of formula (12):

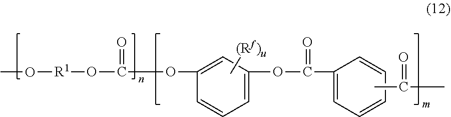

wherein R^{f}, u, and m are as defined in formula (11a), each R¹ is independently a C₆₋₃₀ arylene group, and n is greater than or equal to one, for example 3 to 50, preferably from 5 to 25, and more preferably from 5 to 20. In an aspect, m is 5 to 75 and n is 3 to 50, or m is 10 to 25 and n is 5 to 20, and the molar ratio of isophthalate units to terephthalate units is 80:20 to 20:80. In the foregoing embodiment, the preferred carbonate units are bisphenol A carbonate units, optionally together with resorcinol carbonate units, and the arylate units are poly(isophthalate-terephthalate-resorcinol) ester units, poly(isophthalate-terephthalate-bisphenol-A) ester units, and poly[(isophthalate-terephthalate-resorcinol) ester-co-(isophthalate-terephthalate-bisphenol-A)] ester units. In a specific embodiment, the carbonate and arylate units are present as a poly(isophthalate-terephthalate-resorcinol ester)-co-(resorcinol carbonate)-co-(bisphenol-A carbonate) segment.

The carbonate and arylate segments desirably comprise a minimum amount of saturated hydrocarbon present in the form of substituents or structural groups such as bridging groups or other connective groups. In an aspect, less than or equal to 25 mol %, preferably less than or equal to 15 mol %, and still more preferably less than or equal to 10 mol % of the combined arylate units and carbonate units comprise alkyl, alkoxy, or alkylene groups. In another embodiment, the arylate ester units and the carbonate units are not substituted with non-aromatic hydrocarbon-containing substituents such as alkyl, alkoxy, or alkylene substituents.

The poly(carbonate-siloxane-arylate) comprises siloxane units in an amount of 0.1 to 25 weight percent (wt %). In an aspect, the poly(carbonate-siloxane-arylate) comprises siloxane units in an amount of 0.2 to 10 wt %, preferably 0.2 to 6 wt %, more preferably 0.2 to 5 wt %, and still more preferably 0.25 to 2 wt %, based on the total weight of the poly(carbonate-siloxane-arylate), with the proviso that the siloxane units are provided by polysiloxane units covalently bonded in the polymer backbone of the poly(carbonate-siloxane-arylate); 50 to 99.6 wt % arylate units, and 0.2 to 49.8 wt % carbonate units, wherein the combined weight percentages of the polysiloxane units, arylate units, and carbonate units is 100 wt % of the total weight of the poly(carbonate-siloxane-arylate). In another embodiment, the poly(carbonate-siloxane-arylate) comprises 0.25 to 2 wt % polysiloxane units, 60 to 94.75 wt % arylate units, and 3.25 to 39.75 wt % carbonate units, wherein the combined weight percentages of the polysiloxane units, ester units, and carbonate units is 100 wt % of the total weight of the poly(carbonate-siloxane-arylate).

The poly(carbonate-siloxane-arylate) can be present in the thermoplastic compositions in an amount of 5 to 50 wt %, 30 to 50 wt %, or 35 to 45 wt %, based on the total weight of the thermoplastic compositions. When a flame retardant is present, the thermoplastic compositions can contain 5 to 35 wt % or 10 to 30 wt % of the poly(carbonate-siloxane-arylate) based on the total weight of the thermoplastic compositions.

In addition to the polyester, the poly(carbonate-siloxane-arylate), and the poly(carbonate-siloxane) copolymer, the thermoplastic compositions can include various additives ordinarily incorporated into polymer compositions of this type, with the proviso that the additives are selected so as to not significantly adversely affect the desired properties of the thermoplastic compositions, in particular impact and mechanical properties. Additives include fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives can be used, for example a combination of a heat stabilizer, mold release agent, ultraviolet light stabilizer, and flame retardant. In general, the additives are used in the amounts known to be effective.

A brominated flame retardant can be used. Specific brominated polycarbonate, i.e., a polycarbonate containing brominated carbonate includes units derived from 2,2′,6,6′-tetrabromo-4,4′-isopropylidenediphenol (TBBPA) and carbonate units derived from at least one dihydroxy aromatic compound that is not TBBPA. The dihydroxy aromatic compound can be of formula (4), more preferably dihydroxy aromatic compound (4) containing no additional halogen atoms. In an aspect, the dihydroxy aromatic compound is bisphenol A.

The relative ratio of TBBPA to the dihydroxy aromatic compound used to manufacture the TBBPA copolymer depends on the amount of the TBBPA copolymer used and the amount of bromine desired in the polycarbonate composition. In an aspect, the TBBPA copolymer is manufactured from a composition having 30 to 70 wt % of TBBPA and 30 to 70 wt % of the dihydroxy aromatic compound, preferably bisphenol A, or preferably 45 to 55 wt % of TBBPA and 45 to 55 wt % of the dihydroxy aromatic compound, preferably bisphenol A.

Combinations of different TBBPA copolymers can be used. The TBBPA copolymer can have phenol endcaps such as 2,4,6-tribromophenol endcaps.

The TBBPA copolymers have an Mw from 18,000 to 30,000 Da, preferably 20,000 to 30,000 Da as measured by gel permeation chromatography (GPC) using a crosslinked styrene-divinylbenzene column and calibrated to bisphenol A polycarbonate references.

A brominated flame retardant can also include a brominated oligomer. The term “brominated oligomer” is used herein for convenience to identify a brominated compound comprising at least two repeat units with bromine substitution, and having an Mw of less than 18,000 Da. The brominated oligomer can have an Mw of 1000 to 18,000 Da, preferably 2,000 to 15,000 Da, and more preferably 3,000 to 12,000 Da.

The brominated oligomer can be a brominated polycarbonate oligomer derived from brominated aromatic dihydroxy compounds (e.g., brominated compounds of formula (4)) and a carbonate precursor, or from a combination of brominated and non-brominated aromatic dihydroxy compounds, e.g., of formula (4), and a carbonate precursor. Brominated polycarbonate oligomers are disclosed, for example, in U.S. Pat. Nos. 4,923,933, 4,170,711, and 3,929,908. Examples of brominated aromatic dihydroxy compounds include 2,2-bis(3,5-dibromo-4-hydroxyphenyl)propane, bis(3,5-dibromo-4-hydroxyphenyl)menthanone, and 2,2′,6,6′-tetramethyl-3,3′,5,5′-tetrabromo-4,4′-biphenol. Examples of non-brominated aromatic dihydroxy compounds for copolymerization with the brominated aromatic dihydroxy compounds include bisphenol A, bis(4-hydroxyphenyl) methane, 2, 2-bis(4-hydroxy-3-methylphenyl)propane, 4,4-bis(4-hydroxyphenyl)heptane, and (3,3′-dichloro-4,4′-dihydroxydiphenyl)methane. Combinations of two or more different brominated and non-brominated aromatic dihydroxy compounds can be used.

Other types of brominated oligomers can be used, for example brominated epoxy oligomers. Examples of brominated epoxy oligomers include those derived from bisphenol A, hydrogenated bisphenol A, bisphenol-F, bisphenol-S, novolac epoxies, phenol novolac epoxies, cresol novolac epoxies, N-glycidyl epoxies, glyoxal epoxies dicyclopentadiene phenolic epoxies, silicone-modified epoxies, and epsilon-caprolactone modified epoxies. Combinations of different brominated epoxy oligomers can be used. A specific example of the brominated oligomer is a tetrabromobisphenol A epoxy having 2,4,6-tribromophenol endcaps.

The brominated flame retardants can have a bromine content of 15 to 35 wt % or 20 to 30 wt % based on the total weight of the brominated flame retardants. The thermoplastic compositions can comprise 5 to 35 wt %, 10 to 30 wt %, or 15 to 25 wt % of the brominated flame retardant based on the total weight of the compositions.

In addition to the brominated flame retardant, the thermoplastic compositions can also contain an antimony compound. Useful antimony compound includes antimony trioxide (Sb₂O₃), antimony pentoxide (Sb₂O₅), and antimony-metal compounds, such as sodium antimonate (Na₂SbO₄). In an aspect, the antimony compound is Sb₂O₃.

The antimony compound can be present in an amount of 0.5 to 10 wt %, 1 to 8 wt %, or 2 to 6 wt %, based on the total weight of the thermoplastic compositions.

The thermoplastic compositions can contain an impact modifier. The impact modifier component comprises acrylonitrile-butadiene-styrene polymer (ABS), an acrylonitrile-styrene-butyl acrylate (ASA) polymer, a methyl methacrylate-acrylonitrile-butadiene-styrene (MABS) polymer, a methyl methacrylate-butadiene-styrene (MBS) polymer, and an acrylonitrile-ethylene-propylene-diene-styrene (AES) polymer, or a combination thereof. As used herein, ABS includes bulk polymerized ABS (BABS). The impact modifier can be present in an amount of 5 to 20 wt % or 8 to 12 wt % based on the total weight of the thermoplastic compositions.

The thermoplastic compositions can also contain an epoxy additive. Epoxy compounds useful as additives include epoxy modified acrylic oligomers or polymers (such as a styrene-acrylate-epoxy polymer, prepared from for example a combination of: a substituted or unsubstituted styrene such as styrene or 4-methylstyrene; an acrylate or methacrylate ester of a C₁₋₂₂ alkyl alcohol such as methyl acrylate, methyl methacrylate, ethyl acrylate, butyl acrylate, or the like; and an epoxy-functionalized acrylate such as glycidyl acrylate, glycidyl methacrylate, 2-(3,4-epoxycyclohexyl)ethyl acrylate, 2-(3,4-epoxycyclohexyl)ethyl methacrylate, or the like), or an epoxy carboxylate oligomer based on cycloaliphatic epoxides (such as, for example, 3,4-epoxycyclohexylmethyl-3,4-epoxycyclohexylcarboxylate, or the like). Specific commercially available exemplary epoxy functionalized stabilizers include Cycloaliphatic Epoxide Resin ERL-4221 supplied by Union Carbide Corporation (a subsidiary of Dow Chemical), Danbury, Conn.; and epoxy modified acrylates such as JONCRYL ADR-4300 and JONCRYL ADR-4368, available from Johnson Polymer Inc., Sturtevant, Wis. Epoxy additives can be used in amounts of up to 1 wt %, preferably 0.001 to 1 wt %, more preferably 0.001 to 0.5 wt %, based on the total weight of the thermoplastic composition. In an aspect, the epoxy additive can be included in an amount of 0.001 to 0.3 wt %, preferably 0.01 to 0.3 wt %, and more preferably 0.1 to 0.3 wt %, based on the total weight of the thermoplastic compositions. Use of greater amounts of epoxy compound can cause more splay, i.e., mold lines which fan outward from the point of injection into the mold, and observable to the unaided eye in molded articles comprising the thermoplastic composition.

The thermoplastic compositions can optionally contain a poly(ethylene-vinyl acetate). Poly(ethylene-vinyl acetate) is a random copolymer of ethylene and vinyl acetate. In an aspect, the vinyl acetate content of the poly(ethylene-vinyl acetate) is 1 to 20 wt %, preferably 5 to 15 wt %, with the balance being ethylene content. The poly(ethylene-vinyl acetate) can be present in an amount of 0.1 to 5 wt %, 0.1 to 2 wt %, or 0.5 to 1.5 wt % based on the total weight of the thermoplastic compositions.

The thermoplastic compositions can comprise no more than 8 wt %, for example 0.1 to 8 wt %, 0.5 to 8 wt %, 5 to 8 wt %, or 0.1 to 1 wt % based on the weight of the thermoplastic compositions of an additive package, which includes a processing aid, a heat stabilizer, an antioxidant, an ultra violet light absorber, or a combination thereof.

Examples of the additives that can be used in the additive package include pentaerythritol tetrastearate (PETS), pentaerythritol tetrakis-(3-dodecylthiopropionate) (SEENOX 412S), tetrakis(2,4-di-tert-butylphenyl)[1,1-biphenyl]-4,4′-diylbisphosphonite (PEPQ), monozinc phosphate (MZP), phosphoric acid, hydroxyl octaphenyl benzotriazole, a phosphite stabilizer (e.g., IRGAFOS 168), and a hindered phenol (e.g., IRGAFOS 1076), or a combination thereof.

Optionally, the thermoplastic compositions comprise less than 10 wt %, less than 5 wt %, or less than 2 wt % of polycarbonate homopolymers such as bisphenol A polycarbonate homopolymer or copolycarbonates. As used herein, “less than 10 wt %,” “less than 5 wt %,” and “less than 2 wt %” mean “zero to less than 10 wt %,” “zero to less than 5 wt %,” and “zero to less than 2 wt %” respectively. In a specific embodiment, the thermoplastic compositions are free of polycarbonate homopolymers or copolycarbonates.

The thermoplastic compositions can have good chemical resistance, in particular resistance to aggressive disinfectants such as SANI-CLOTH AF3 or SANI-CLOTH PLUS. In an aspect, an ASTM tensile bar comprising the thermoplastic compositions has a tensile strength retention of at least 90% after exposure of the bar for 7 days to SANI-CLOTH AF3 at a temperature of 23° C. under 1% strain compared to a non-exposed reference tested at the same temperature, and a tensile elongation at break retention of at least 30%, at least 50%, at least 70%, or least 80% after exposure of the bar for 7 days to SANI-CLOTH AF3 at a temperature of 23° C. under 1% strain compared to a non-exposed reference tested at the same temperature. Alternatively or in addition, an ASTM tensile bar comprising the thermoplastic compositions has a tensile strength retention of at least 90% after exposure of the bar for 7 days to SANI-CLOTH PLUS at a temperature of 23° C. under 1% strain compared to a non-exposed reference tested at the same temperature, and a tensile elongation at break retention of at least 30%, at least 50%, at least 70%, or least 80% after exposure of the bar for 7 days to SANI-CLOTH PLUS at a temperature of 23° C. under 1% strain compared to a non-exposed reference tested at the same temperature.

Polycarbonate compositions can have desireable flame-retardant properties. In measuring flame retardance, the UL94 standard is associated with a rating of V0, V1, or V2 wherein a rating of V0 is better than V1 and a rating of V1 is better than V2. The UL94 testing standard dictates that thermoplastic compositions be formed into a molded article having a specified thickness. The thinner the article, the more difficult it can be to achieve a rating of V0, V1, or V2. A molded sample of thermoplastic compositions disclosed herein can achieve a UL94 V0 or V1 rating at a thickness of 1.5 mm.

The thermoplastic compositions can be manufactured by various methods known in the art. For example, polyester, poly(carbonate-siloxane) copolymer or polycarbonate siloxane-arylate, and other components, if present, are first blended, in a high-speed mixer or by hand mixing. The blend is then fed into the throat of a twin-screw extruder via a hopper. Alternatively, at least one of the components can be incorporated into the composition by feeding it directly into the extruder at the throat and/or downstream through a side stuffer, or by being compounded into a master batch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

Shaped, formed, casted, or molded articles comprising the thermoplastic compositions are also provided. The thermoplastic compositions can be molded into useful shaped articles by a variety of methods, such as injection molding, extrusion, rotational molding, blow molding, and thermoforming. The article can be a molded article, a thermoformed article, an extruded film, an extruded sheet, a honeycomb structure, one or more layers of a multi-layer article, a substrate for a coated article, and a substrate for a metallized article.

In an embodiment, the article can be a healthcare product or a component of a healthcare product such as an artificial joint, an artificial organ, an A-V shunt, a balloon, a balloon pump, a biosensor, a blood bag, a blood filter housing, a blood pump, a cannula, a cardiac assist device, a cardiac pacemaker and defibrillator, a catheter, a defibrillator lead, a dialyzer, a disc, an extra-corporeal device, a filter, a food tray, a guidewire, a hygienic barrier, a heart valve, an implantable prosthesis, an implantable device such as a pacemaker, defibrillator, drug delivery pump, diagnostic recorder, cochlear implant, drug delivery device, glucose monitor, or neurostimulator, an in-dwelling access device or port, an intravenous connector, a ligature, a medical appliance, a medical equipment housing, a medical storage tray, a medical tubing, a membrane such as a membrane for filtration or cell encapsulation, a monitor housing, an orthopedic implant and syringe, a pacemaker lead, a plate, a scaffolding, a shunt, a solution bag, a stent, a support, a syringe, a transfusion joint, a vascular graft, a valve, a wound dressing, an intravenous connector, or an animal cage.

The above described and other features are exemplified by the following examples. In the examples, unless otherwise specified, the percent (%) of the components is wt % based on the total weight of the composition.

### EXAMPLES

The materials used in the Examples are described in Table 1.

TABLE 1

| Component | Chemical Description | Source |
|---|---|---|
| PCCD | Poly(1,4-cyclohexane-dimethanol-1,4- | SABIC |
| | cyclohexane dicarboxylate) | |
| PCTG | Poly(20 mol % ethylene | EASTMAN |
| | terephthalate)-co-(80 mol % 1,4- | CHEMICAL |
| | cyclohexanedimethylene terephthalate), | CO. |
| | Mw of 70,000 as determined by GPC | |
| | using polystyrene standards | |
| PBT-1 | Poly(butylene terephthalate) having | SABIC |
| | an intrinsic viscosity of 1.2 dl/g as | |
| | measured in 1:1 weight to weight | |
| | mixture of phenol:1,1,2,2-tetrachloro | |
| | ethane at 30° C. | |
| PBT-2 | Poly(butylene terephthalate) having | SABIC |
| | an intrinsic viscosity of 0.70 dl/g as | |
| | measured in 1:1 weight to weight | |
| | mixture of phenol:1,1,2,2-tetrachloro | |
| | ethane at 30° C. | |
| SiPC-1 | PDMS (polydimethylsiloxane) − Bisphenol | SABIC |
| | A Polycarbonate copolymer, 20 | |
| | wt % siloxane, average PDMS block length | |
| | of 45 units (D45), Mw 30,000 Da | |
| | as determined by GPC using bisphenol | |
| | A polycarbonate standards, p- | |
| | cumylphenol (PCP) end-capped | |
| SiPC-2 | PDMS (polydimethylsiloxane) − Bisphenol | SABIC |
| | A Polycarbonate copolymer, 6 | |
| | wt % siloxane, average PDMS block | |
| | length of 45 units (D45), Mw 23,000 Da | |
| | as determined by GPC using bisphenol | |
| | A polycarbonate standards, para- | |
| | cumylphenol (PCP) end-capped | |
| ITR-PC-Si | Polysiloxane-ITR (isophthalic | SABIC |
| | acid-terephthalic acid-resorcinol) − bisphenol- | |
| | A copoly(ester-carbonate), ester | |
| | content 83 mol %, siloxane content 1 wt % | |
| | (average siloxane chain length 10 | |
| | containing eugenol endcaps), interfacial | |
| | polymerization, Mw = 22,500 to 26,500 | |
| | Da, para-cumyl phenol end-capped | |
| HFD | Sebacic acid-bisphenol A poly(ester- | SABIC |
| | carbonate), produced via interfacial | |
| | polymerization, 8.3 mol % sebacic acid, | |
| | Mw 35,400 Da as determined via | |
| | GPC using polycarbonate standards, | |
| | para-cumylphenol (PCP) end-capped | |
| PC-1 | Bisphenol A polycarbonate homopolymer, | SABIC |
| | interfacial polymerization, Mw | |
| | 30,000 Da as determined by GPC using | |
| | bisphenol A polycarbonate standards, | |
| | phenol end-capped | |
| PC-2 | Bisphenol A polycarbonate homopolymer, | SABIC |
| | interfacial polymerization, Mw | |
| | 22,000 Da as determined by GPC using | |
| | bisphenol A polycarbonate standards, | |
| | phenol end-capped | |
| ADR4368 | Styrene-acrylate copolymer with glycidyl | BASF |
| | groups (JONCRYL) | |
| BrPC | Brominated Bisphenol A Polycarbonate, | SABIC |
| | Mw = 23,000-25,0000 Da, 26 wt % | |
| | Br | |
| IM | Methyl methacrylate-butadiene-styrene | |
| | copolymer | |
| Sb₂O₃ | Sb₂O₃ 80% in poly(butylene terephthalate) | |
| EVA | Poly(ethylene-vinyl acetate) with | VERSALIS |
| | vinyl acetate content of 9 wt. % | |
| HPA | Tetrakis[methylene(3,5-di-tert-butyl-4- | AKROCHEM |
| | hydroxyhydrocinnamate)]methane | |
| PETS | Pentaerythritol tetrastearate | |
| MZP | Phosphoric acid, zinc salt (2:1) | |
| PHOS | Phosphorous acid, 45% vol. in water | LABCHEM/ |
| | | FISHER |
| | | SCIENTIFIC |
| DEMI | Demineralized water | |
| PEPQ | Tetrakis(2,4-di-tert-butylphenyl)[1,1- | CLARIANT |
| | biphenyl]-4,4′diylbisphosphonite | |
| ABS | Acrylonitrile butadiene styrene | SABIC |

### Blending, Extrusion, and Molding Conditions.

The compositions were prepared by pre-blending all constituents in a dry-blend and tumble mixed for 15 minutes. In all the formulations, the indicated amount of an additive package (antioxidants, mold release agents, and/or stabilizers) was present. The pre-blend was fed directly to a co-rotation twin screw extruder. The extrudate was pelletized and dried in a dehumidifying dryer at 110° C. for 2 hours. To make test specimens, the dried pellets were injection molded in an ENGEL molding machine to form appropriate test samples. Compositions were compounded and molded at a temperature of 230 to 280° C., though it will be recognized by one skilled in the art that the method cannot be limited to these temperatures.

The ASTM tests performed are summarized in Table 2.

TABLE 2

| Description | Test standards | Testing Conditions |
|---|---|---|
| Tensile | ASTM D 638 | 50 min/min, Type I sample |
| Flexural modulus | ASTM D 790 | 1.3 mm/min, 50 mm span |
| Notched Izod Impact (INI) | ASTM D 256 | 5 lbf/ft, 23° C., 3.2 mm |
| Heat deflection | ASTM D 648 | 3.2 mm unannealed |
| temperature (HDT) | | |
| Haze and Transmission | ASTM D1003 | Procedure A, under D65 |
| | | illumination, with a 10 |
| | | degrees observer, at a |
| | | sample thickness of 2.54 mm |
| | | using a Haze-Gard test device |

Environmental Stress Cracking Resistance (“ESCR”) describes the accelerated failure of polymeric materials, as a combined effect of environment, temperature, and stress. The failure mainly depends on the characteristics of the material, chemical, exposure condition, and the magnitude of the stress. The tests followed ASTM D543 standard and used ASTM tensile bars under 1% strain for 7 days at room temperature (23° C.) with the indicated chemical applied on the surface. After 7 days, plus 24 hours conditioning at 23° C. and 50% relative humidity, the retention of tensile strength and elongation at break were measured according to ASTM D 638 and compared to the non-exposed reference.

Flammability tests were performed following the procedure of Underwriter's Laboratory Bulletin 94 entitled “Tests for Flammability of Plastic Materials for Parts in Devices and Appliances” (ISBN 0-7629-0082-2), Fifth Edition, Dated Oct. 29, 1996, incorporating revisions through and including Dec. 12, 2003. Several ratings can be applied based on the rate of burning, time to extinguish, ability to resist dripping, and whether or not drips are burning. According to this procedure, materials can be classified as UL94 HB, V0, V1, V2, 5VA, or 5VB. The test specimens were aged at 23° C., 50% RH for 48 hours or 70° C. for 168 hours before testing.

### Comparative Example 1 and Examples 2-5

Comparative example 1 and examples 2-5 illustrate the effects of replacing bisphenol A polycarbonate homopolymers in a PBT-containing composition with different polycarbonate copolymers on chemical resistance, heat, and mechanical properties. Formulations and results are shown in Table 3.

TABLE 3

| Component | Unit | CEx 1 | Ex 2 | Ex 3 | Ex 4 | Ex 5 |
|---|---|---|---|---|---|---|
| PBT-1 | wt % | 41.59 | 41.59 | 41.59 | 41.59 | 41.59 |
| PBT-2 | wt % | 7.75 | 7.75 | 7.75 | 7.75 | 7.75 |
| PC1 | wt % | 12 | | | | |
| SiPC-1 | wt % | | 12 | | | |
| SiPC-2 | wt % | | | 12 | | |
| ITR-PC-Si | wt % | | | | 12 | |
| HFD | wt % | | | | | 12 |
| BrPC | wt % | 20 | 20 | 20 | 20 | 20 |
| IM | wt % | 12 | 12 | 12 | 12 | 12 |
| Sb₂O₃ | wt % | 5.3 | 5.3 | 5.3 | 5.3 | 5.3 |
| EVA | wt % | 0.8 | 0.8 | 0.8 | 0.8 | 0.8 |
| ABS | wt % | 0.1 | 0.1 | 0.1 | 0.1 | 0.1 |
| PETS | wt % | 0.3 | 0.3 | 0.3 | 0.3 | 0.3 |
| MZP | wt % | 0.1 | 0.1 | 0.1 | 0.1 | 0.1 |
| HPA | wt % | 0.06 | 0.06 | 0.06 | 0.06 | 0.06 |
| Properties | | | | | | |
| Tensile strength | MPa | 48.6 | 43.7 | 45.2 | 45.7 | 47.9 |
| at yield | | | | | | |
| Tensile strength | MPa | 36.2 | 34 | 33.9 | 39.1 | 33.4 |
| at break | | | | | | |
| Tensile elongation | % | 4 | 3.6 | 3.6 | 3.7 | 3.9 |
| at yield | | | | | | |
| Tensile elongation | % | 26.2 | 18 | 20.7 | 10.3 | 17.8 |
| at break | | | | | | |
| Tensile modulus | MPa | 2060 | 1936 | 2034 | 1988 | 2038 |
| Shrinkage | % | 0.95 | 0.94 | 0.97 | 0.86 | 0.82 |
| INI at 23° C. | KJ/ | 6.97 | 26.59 | 9.17 | 6.81 | 33.19 |
| | m² | | | | | |
| INI std. dev. | % | 2.6 | 14.38 | 2.69 | 3.02 | 20.44 |
| HDT at 0.45 MPa | ° C. | 96.6 | 105.35 | 94.4 | 98.4 | 105.15 |
| ESCR | | | | | | |
| performance | | | | | | |
| SANI-CLOTH | | | | | | |
| AF3 | | | | | | |
| Tensile strength | MPa | 47.4 | 42.2 | 44.1 | 44.2 | 46.7 |
| at yield | % | 21.6 | 14.6 | 18.7 | 10.0 | 9.8 |
| Tensile elongation | | | | | | |
| at break | | | | | | |
| Tensile strength | % | 97.5 | 96.6 | 97.6 | 96.7 | 97.5 |
| retention | | | | | | |
| Tensile elongation | % | 82.4 | 91.1 | 90.3 | 97.1 | 55.1 |
| retention | | | | | | |
| SANI-CLOTH | | | | | | |
| PLUS | | | | | | |
| Tensile strength | MPa | 46.7 | 42 | 43.9 | 43.4 | 46.3 |
| at yield | | | | | | |
| Tensile elongation | % | 15.7 | 16.3 | 23.5 | 3.4 | 10 |
| at break | | | | | | |
| Tensile strength | % | 96.09 | 96.11 | 97.12 | 94.97 | 96.66 |
| retention | | | | | | |
| Tensile elongation | % | 59.92 | 90.56 | 113.53 | 33.01 | 56.18 |
| retention | | | | | | |

The data shows that when the bisphenol A polycarbonate homopolymer in a PBT-containing composition is replaced with SiPC-1 or SiPC-2, the composition can have improved resistance against an aggressive disinfectant: SANI-CLOTH AF3, while at the same time showing enhanced impact performance. Comparing CEx 1 with Ex 2, when PC1 in CEx 1 is replaced with the same amount of SiPC-1, all other components remaining the same, the tensile elongation at break retention is improved from 82.4% to 91.1% after exposure of an ASTM tensile bar for 24 hours to SANI-CLOTH AF3 at a temperature of 23° C. under 1% strain compared to a non-exposed reference tested at the same temperature. Similarly, when PC1 in CEx 1 is replaced with the same amount of SiPC-1, all other components remaining the same, the tensile elongation at break retention is improved from 59.92% to 90.56% after exposure of an ASTM tensile bar for 24 hours to SANI-CLOTH PLUS at a temperature of 23° C. under 1% strain compared to a non-exposed reference tested at the same temperature. Replacing PC1 in CEx 1 with SiPC-1 also improves the notched Izod impact from 6.97 J/m to 26.59 J/m.

Comparing Ex 3 with CEx 1, the data shows that similar beneficial results are observed when PC1 in CEx 1 is replaced with SiPC-2.

Comparing CEx 1 with Ex 4, when PC1 in CEx 1 is replaced with the same amount of ITR-PC-Si, all other components remaining the same, the tensile elongation at break retention is improved from 82.4% to 97.1% after exposure of an ASTM tensile bar for 24 hours to SANI-CLOTH AF3 at a temperature of 23° C. under 1% strain compared to a non-exposed reference tested at the same temperature.

Replacing PC1 in CEx 1 with HFD, on the other hand, has limited effects on improving the chemical resistance of CEx 1.

### Comparative Example 6 and Examples 7-10

Comparative example 6 and examples 7-10 illustrate the effects of replacing a bisphenol A polycarbonate homopolymer in a PCCD-containing composition with different polycarbonate copolymers on chemical resistance, heat, mechanical, and optical properties. Formulations and results are shown in Table 4.

TABLE 4

| Component | Unit | CEx 6 | Ex 7 | Ex 8 | Ex 9 | CEx 10 |
|---|---|---|---|---|---|---|
| PCCD | wt % | 60 | 60 | 60 | 60 | 60 |
| PC1 | wt % | 25 | | | | |
| PC2 | wt % | 14.05 | | | | |
| SiPC-1 | wt % | | 39.05 | | | |
| SiPC-2 | wt % | | | 39.05 | | |
| ITR-PC-Si | wt % | | | | 39.05 | |
| HFD | wt % | | | | | 39.05 |
| ADR4368 | wt % | 0.25 | 0.25 | 0.25 | 0.25 | 0.25 |
| DEMI | wt % | 0.5 | 0.5 | 0.5 | 0.5 | 0.5 |
| PEPQ | wt % | 0.15 | 0.15 | 0.15 | 0.15 | 0.15 |
| PHOS | Wt % | 0.05 | 0.05 | 0.05 | 0.05 | 0.05 |
| Properties | | | | | | |
| Tensile strength | MPa | 45.7 | 38.1 | 42.4 | 40.1 | 43.4 |
| at yield | | | | | | |
| Tensile strength | MPa | 53.4 | 40.9 | 46.1 | 53.4 | 50 |
| at break | | | | | | |
| Tensile elongation | % | 5.5 | 5 | 5.2 | 5.5 | 5 |
| at yield | | | | | | |
| Tensile elongation | % | 196.9 | 179.8 | 197 | 107.3 | 220.3 |
| at break | | | | | | |
| Tensile modulus | MPa | 1574 | 1325 | 1468 | 1490 | 1520 |
| Flexural modulus | MPa | 1570 | 1240 | 1490 | 1460 | 1430 |
| INI at 23° C. | J/m | 1070 | 1270 | 1110 | 931 | 1050 |
| INI at −30° C. | J/m | 77.2 | 1230 | 98.2 | 98.2 | 86.8 |
| HDT at 0.45 MPa | ° C. | 85.2 | 76.8 | 81.2 | 65.65 | 80.55 |
| HDT at 1.82 MPa | ° C. | 73.1 | 66.2 | 71.05 | 59.8 | 70.1 |
| Transmission | % | 88.7 | 43.5 | 89.4 | 6.7 | 89.5 |
| Haze | % | 4 | 90.3 | 4.1 | 103 | 4.4 |
| ESCR | | | | | | |
| performance | | | | | | |
| SANI-CLOTH | | | | | | |
| AF3 | | | | | | |
| Tensile strength | MPa | 0 | 37.6 | 0 | 39.5 | 0 |
| at yield | | | | | | |
| Tensile elongation | % | 3.1 | 65.6¹ | 3.8 | 106.1 | 3 |
| at break | | | | | | |
| Tensile strength | % | 0 | 99 | 0 | 99 | 0 |
| retention | | | | | | |
| Tensile elongation | % | 0 | 36 | 2 | 99 | 1 |
| retention | | | | | | |
| SANI-CLOTH | | | | | | |
| PLUS | | | | | | |
| Tensile strength | MPa | 45 | 37.5 | | 39.3 | 42.8 |
| at yield | | | | | | |
| Tensile elongation | % | 44.2² | 163.2 | | 97.7 | 61.7³ |
| at break | | | | | | |
| Tensile strength | % | 98 | 98 | | 98 | 99 |
| retention | | | | | | |
| Tensile elongation | % | 22 | 91 | | 91 | 28 |
| retention | | | | | | |

¹standard deviation: 46.6
²standard deviation: 53.2
³standard deviation: 62.9

The data shows that when the bisphenol A polycarbonate homopolymer in a PCCD-containing composition is replaced with ITR-PC-Si, the composition has significantly improved chemical resistance. Comparing CEx 6 with Ex 9, when PC1 and PC2 in CEx 6 are replaced with the same amount of ITR-PC-Si, all other components remaining the same, the tensile strength and tensile elongation at break retentions are both improved from 0% to 99% after exposure of an ASTM tensile bar for 7 days to SANI-CLOTH AF3 at a temperature of 23° C. under 1% strain compared to a non-exposed reference tested at the same temperature. Similarly, when PC1 and PC2 in CEx 6 are replaced with the same amount of ITR-PC-Si, the tensile elongation at break retention is improved from 22% to 91% after exposure of an ASTM tensile bar for 7 days to SANI-CLOTH PLUS at a temperature of 23° C. under 1% strain compared to a non-exposed reference tested at the same temperature. Replacing PC1 and PC2 in CEx 6 with ITR-PC-Si reduces the HDT. Nonetheless, the composition containing ITR-PC-Si can be used in applications that do not have demanding requirements for high heat properties.

Comparing Ex 7 with CEx 6, the data shows that replacing PC1 and PC2 in CEx 6 with SiPC-1 improves the chemical resistance while maintaining heat performance.

Replacing PC1 and PC2 in CEx 6 with HFD or SiPC2, on the other hand, have limited effects on improving the chemical resistance of CEx 6.

### Examples 11-20

Compositions containing different polyesters and either a poly(carbonate-siloxane) copolymer or a poly(carbonate-siloxane-arylate) were formulated and tested for chemical resistance, mechanical and flame-retardant properties. Formulations and test results are shown in Table 5.

TABLE 5

| Component | Unit | Ex 11 | Ex 12 | Ex 13 | Ex 14 | Ex 15 | Ex 16 | Ex 17 | Ex 18 | Ex 19 | Ex 20 |
|---|---|---|---|---|---|---|---|---|---|---|---|
| PCCD | wt % | 60 | 60 | | | 60 | 60 | | | | |
| PCTG | | | | 60 | 60 | | | 60 | 60 | | |
| PBT-1 | wt % | | | | | | | | | 41.59 | 41.59 |
| PBT-2 | wt % | | | | | | | | | 7.75 | 7.75 |
| SiPC-1 | wt % | | 39.05 | | 39.05 | | | | | 12 | |
| SiPC-2 | wt % | | | | | | | | | | 12 |
| ITR-PC-Si | wt % | 39.05 | | 39.05 | | 26 | 12.95 | 26 | 12.95 | | |
| ADR4368 | wt % | 0.25 | 0.25 | 0.25 | 0.25 | 0.25 | 0.25 | 0.25 | 0.25 | | |
| BrPC | wt % | | | | | 10 | 20 | 10 | 20 | 20 | 20 |
| IM | | | | | | | | | | 12 | 12 |
| Sb₂O₃ | wt % | | | | | 2.65 | 5.3 | 2.65 | 5.3 | 5.3 | 5.3 |
| EVA | wt % | | | | | 0.4 | 0.8 | 0.4 | 0.8 | 0.8 | 0.8 |
| DEMI | wt % | 0.5 | 0.5 | 0.5 | 0.5 | 0.5 | 0.5 | 0.5 | 0.5 | | |
| PEPQ | wt % | 0.15 | 0.15 | 0.15 | 0.15 | 0.15 | 0.15 | 0.15 | 0.15 | | |
| PHOS | wt % | 0.05 | 0.05 | 0.05 | 0.05 | 0.05 | 0.05 | 0.05 | 0.05 | | |
| ABS | wt % | | | | | | | | | 0.1 | 0.1 |
| PETS | wt % | | | | | | | | | 0.3 | 0.3 |
| MZP | wt % | | | | | | | | | 0.1 | 0.1 |
| DHPA | wt % | | | | | | | | | 0.06 | 0.06 |
| Properties | | | | | | | | | | | |
| Tensile strength at yield | MPa | 40 | 38.1 | 54.8 | 45.2 | 42.7 | 44.3 | 53.0 | 52.5 | 41.8 | 43.9 |
| Tensile strength at break | MPa | 35.2 | 40.3 | 52.3 | 46.2 | 41.3 | 43.3 | 53.8 | 49.0 | 34.1 | 36.0 |
| Tensile elong. at yield | % | 4.1 | 5.2 | 6.3 | 5.6 | 4.7 | 5.2 | 5.9 | 5.6 | 3.9 | 3.9 |
| Tensile elong. at break | % | 105.5 | 162.5 | 135.9 | 137.0 | 134.9 | 156.1 | 141.6 | 126.3 | 55.0 | 73.3 |
| St. dev. elong. at break | % | 6.6 | 9.8 | 7.2 | 3.9 | 6.4 | 12.6 | 8.3 | 162.2 | 16.5 | 23.8 |
| Tensile modulus | MPa | 1440 | 1270 | 1900 | 1630 | 1480 | 1490 | 1900 | 1900 | 1860 | 1980 |
| INI at 23° C. | J/m | 933 | 1240 | 1160 | 1280 | 970 | 127 | 137 | 98 | 659 | 683 |
| St. dev. INI | % | 11 | 30 | 25 | 10 | 6 | 8 | 7 | 17 | 8 | 5 |
| HDT at 0.45 MPa | ° C. | 69 | 81 | 99 | 94 | 76 | 83 | 97 | 94 | 111 | 121 |
| UL94 at 1.5 mm (23° C., | | NC | NC | NC | NC | V2 | V0 | V2 | V0 | V1 | V0 |
| 48 h/70° C., 168 h) | | | | | | | | | | | |
| ESCR performance | | | | | | | | | | | |
| SANI-CLOTH AF3 | | | | | | | | | | | |
| Tensile strength at yield | MPa | 39.7 | 37.8 | 53.6 | 44.4 | 41.6 | 43.6 | 52.2 | 51.5 | 41.3 | 43.0 |
| Tensile elong. at break | % | 108.6 | 80.2 | 135.6 | 124.5 | 130.8 | 79.6 | 128.2 | 98.7 | 55.1 | 114.5 |
| St. dev. elong. at break | % | 3.3 | 28.7 | 12.2 | 33.1 | 13.1 | 66.4 | 10.7 | 40.3 | 15.4 | 35.6 |
| Tens. strength retention | % | 99 | 99 | 98 | 98 | 97 | 98 | 98 | 98 | 99 | 98 |
| Tensile elong. retention | % | 103 | 49 | 100 | 91 | 97 | 51 | 91 | 78 | 100 | 156 |
| SANI-CLOTH PLUS | | | | | | | | | | | |
| Tensile strength at yield | MPa | 39.9 | 37.7 | 54 | 44.7 | 42.0 | 43.5 | 52.2 | 51.2 | 41.4 | 42.6 |
| Tensile elong. at break | % | 102.6 | 159.2 | 129.5 | 140.1 | 122.4 | 158.2 | 131.8 | 128.1 | 55.6 | 83.2 |
| St. dev. elong. at break | % | 4.2 | 9.6 | 13.8 | 5.7 | 16.5 | 13.0 | 36.8 | 22.9 | 25.0 | 27.0 |
| Tens. strength retention | % | 100 | 99 | 99 | 99 | 98 | 98 | 98 | 98 | 99 | 97 |
| Tensile elong. retention | % | 97 | 98 | 95 | 102 | 91 | 101 | 93 | 101 | 101 | 114 |

NC = not classified (no rating in the UL94 vertical burn test)

All the tested formulations have excellent chemical resistance achieving a tensile strength retention or tensile elongation at break retention of greater than 90% after exposure of an ASTM tensile bar for 7 days to SANI-CLOTH AF3 or SANI-CLOTH PLUS at a temperature of 23° C. under 1% strain compared to a non-exposed reference tested at the same temperature. When a flame retardant is used, the compositions (Ex 15-20) can also have a V0-V2 UL rating.

Further included in this disclosure are the following specific aspects, which do not necessarily limit the claims.

Aspect 1. A thermoplastic composition comprising, based on the total weight of the thermoplastic composition: 40 to 70 wt % of a polyester; 5 to 50 wt % of a poly(carbonate-siloxane) copolymer, a poly(carbonate-siloxane-arylate), or a combination thereof; and 0.1 to 8 wt % of an additive comprising a processing aid, a heat stabilizer, an antioxidant, an ultra violet light absorber, or a combination thereof, wherein an ASTM tensile bar comprising the composition has a tensile strength retention of at least 90% after exposure of the bar for 7 days to SANI-CLOTH AF3 at a temperature of 23° C. under 1% strain compared to a non-exposed reference tested at the same temperature, and a tensile elongation at break retention of at least 80% after exposure of the bar for 7 days to SANI-CLOTH AF3 at a temperature of 23° C. under 1% strain compared to a non-exposed reference tested at the same temperature, the tensile strength retention and tensile elongation at break retention are measured according to ASTM D 638 and compared to the non-exposed reference.

Aspect 2. The thermoplastic composition of Aspect 1, wherein the composition comprises less than 10 wt %, less than 5 wt %, or less than 2 wt % of polycarbonate homopolymers, based on the total weight of the thermoplastic composition.

Aspect 3. The thermoplastic composition of Aspect 1 or Aspect 2, wherein the polyester comprises a poly(1,4-cyclohexane-dimethanol-1,4-cyclohexane dicarboxylate), a poly(ethylene terephthalate)-co-(1,4-cyclohexanedimethylene terephthalate), a polybutylene terephthalate, a polyethylene terephthalate, or a combination thereof.

Aspect 4. The thermoplastic composition of any one or more of Aspects 1 to 3, wherein the thermoplastic composition comprises the poly(carbonate-siloxane) copolymer, which comprises bisphenol A carbonate units and siloxane units of the formula (7a), (7b), (9a), (9b), (9c), or a combination thereof, wherein E has an average value of 5 to 120, preferably siloxane units of the formula (9a), wherein E has an average value of 5 to 80.

Aspect 5. The thermoplastic composition of any one or more of Aspects 1 to 3, wherein the thermoplastic composition comprises the poly(carbonate-siloxane-arylate), which comprises 0.2 to 10 wt % siloxane units, 50 to 99.6 wt % arylate units, and 0.2 to 49.8 wt % carbonate units, each based on the weight of the poly(carbonate-siloxane-arylate); and the arylate units are isophthalate-terephthalate-resorcinol ester units; the carbonate units are bisphenol A carbonate units, resorcinol carbonate units, or a combination thereof; and the siloxane units are of the formula (7a), (7b), (9a), (9b), (9c), or a combination thereof, wherein E has an average value of 5 to 20.

Aspect 6. The thermoplastic composition of any one of Aspects 1 to 3, comprising, based on the total weight of the thermoplastic composition: 50 to 70 wt % or 55 to 65 wt % of the polyester, which comprises a poly(1,4-cyclohexane-dimethanol-1,4-cyclohexane dicarboxylate), a poly(ethylene terephthalate)-co-(cyclohexanedimethylene terephthalate), or a combination thereof; and 30 to 50 wt % or 35 to 45 wt % of the poly(carbonate-siloxane) copolymer, the poly(carbonate-siloxane) copolymer comprising bisphenol A carbonate units and siloxane units of the formula (9a), wherein E has an average value of 10 to 100, 20 to 80, or 30 to 70, and optionally the poly(carbonate-siloxane) copolymer has a siloxane content of 10 to 30 wt % based on the total weight of the poly(carbonate-siloxane).

Aspect 7. The thermoplastic composition of any one of Aspects 1 to 3, comprising, based on the total weight of the thermoplastic composition: 50 to 70 wt % or 55 to 65 wt % of the polyester, which comprises a poly(1,4-cyclohexane-dimethanol-1,4-cyclohexane dicarboxylate), a poly(ethylene terephthalate)-co-(cyclohexanedimethylene terephthalate), or a combination thereof; 5 to 50 wt % or 10 to 30 wt % of the poly(carbonate-siloxane) copolymer; and 5 to 35 wt % or 10 to 30 wt % of a flame retardant, preferably a brominated flame retardant; wherein the poly(carbonate-siloxane) copolymer comprises bisphenol A carbonate units and siloxane units of the formula (9a), wherein E has an average value of 10 to 100, 20 to 80, or 30 to 70 and optionally the poly(carbonate-siloxane) copolymer has a siloxane content of 10 to 30 wt % based on the total weight of the poly(carbonate-siloxane).

Aspect 8. The thermoplastic composition of any one or more of Aspects 1 to 3, comprising, based on the total weight of the thermoplastic composition: 40 to 60 wt % or 45 to 55 wt % of the polyester which comprises a polybutylene terephthalate; 5 to 50 wt % or 10 to 30 wt % of the poly(carbonate-siloxane) copolymer; and 5 to 35 wt % or 10 to 30 wt % of a flame retardant, preferably a brominated flame retardant; wherein the poly(carbonate-siloxane) copolymer comprises bisphenol A carbonate units and siloxane units of the formula (9a), wherein E has an average value of 10 to 100, 20 to 80, or 30 to 70, and optionally the poly(carbonate-siloxane) copolymer has a siloxane content of 10 to 30 wt % based on the total weight of the poly(carbonate-siloxane).

Aspect 9. The thermoplastic composition of Aspect 8, further comprising, based on the total weight of the thermoplastic composition, 5 to 20 wt % of an impact modifier comprising acrylonitrile-butadiene-styrene polymer, an acrylonitrile-styrene-butyl acrylate polymer, a methyl methacrylate-acrylonitrile-butadiene-styrene polymer, a methyl methacrylate-butadiene-styrene polymer, and an acrylonitrile-ethylene-propylene-diene-styrene polymer, or a combination thereof, preferably 8 to 12 wt % of a methyl methacrylate-acrylonitrile-butadiene-styrene polymer.

Aspect 10. The thermoplastic composition of Aspect 8 or Aspect 9, wherein the polyester comprises a first polybutylene terephthalate with an intrinsic viscosity of 1 to 1.5 deciliter/gram (dl/g) as measured in a 60:40 phenol/tetrachloroethane mixture; and a second polybutylene terephthalate with an intrinsic viscosity of 0.9 to 0.3 dl/g as measured in a 60:40 phenol/tetrachloroethane mixture, and the weight ratio of the first polybutylene terephthalate relative to the second polybutylene terephthalate is 10:1 to 2:1, preferably 8:1 to 4:1.

Aspect 11. The thermoplastic composition of any one or more of Aspects 1 to 3, comprising, based on the total weight of the thermoplastic composition: 50 to 70 wt % or 55 to 65 wt % of the polyester, which comprises a poly(1,4-cyclohexane-dimethanol-1,4-cyclohexane dicarboxylate), a poly(ethylene terephthalate)-co-(1,4-cyclohexanedimethylene terephthalate), or a combination thereof; and 30 to 50 wt % or 35 to 45 wt % of the poly(carbonate-siloxane-arylate), which comprises, based on the weight of the poly(carbonate-siloxane-arylate): 50 to 99.6 wt % isophthalate-terephthalate-resorcinol ester units; 0.2 to 49.8 wt % of bisphenol A carbonate units; and 0.2 to 10 wt % siloxane units of the formula (9a), wherein E has an average value of 5 to 20.

Aspect 12. The thermoplastic composition of any one or more of Aspects 1 to 3, comprising, based on the total weight of the thermoplastic composition, 50 to 70 wt % or 40 to 60 wt % of the polyester, which comprises a poly(1,4-cyclohexane-dimethanol-1,4-cyclohexane dicarboxylate), a poly(ethylene terephthalate)-co-(cyclohexanedimethylene terephthalate), or a combination thereof; 5 to 35 wt % or 10 to 30 wt % of the poly(carbonate-siloxane-arylate); and 5 to 35 wt % or 10 to 30 wt % of a flame retardant, preferably a brominated flame retardant; wherein the poly(carbonate-siloxane-arylate) comprises, based on the weight of the poly(carbonate-siloxane-arylate): 50 to 99.6 wt % isophthalate-terephthalate-resorcinol ester units; 0.2 to 49.8 wt % of bisphenol A carbonate units; and to 10 wt % siloxane units of the formula (9a), wherein E has an average value of 5 to 20.

Aspect 13. The thermoplastic composition of any one or more of Aspects 1-12, further comprising 0.5 to 10 wt % of an antimony compound based on the total weight of the thermoplastic composition, and optionally the antimony compound is Sb₂O₃.

Aspect 14. An article comprising the thermoplastic composition of any one or more of Aspects 1 to 13.

Aspect 15. The article of Aspect 14, wherein the article is a healthcare product or a component thereof.

The singular forms “a,” “an,” and “the” include plural referents unless the context clearly dictates otherwise. “Or” means “and/or” unless clearly indicated otherwise by context.

The endpoints of all ranges directed to the same component or property are inclusive and independently combinable (e.g., ranges of “less than or equal to 25 wt %, or to 20 wt %,” is inclusive of the endpoints and all intermediate values of the ranges of “5 to 25 wt %,” etc.). Disclosure of a narrower range or more specific group in addition to a broader range is not a disclaimer of the broader range or larger group.

“Optional” or “optionally” means that the subsequently described event or component may or may not occur, and that the description includes instances where the event occurs and instances where it does not. Unless defined otherwise, technical and scientific terms used herein have the same meaning as is commonly understood by one of skill in the art to which this disclosure belongs. A “combination” is inclusive of blends, mixtures, alloys, reaction products, and the like. The terms “first,” “second,” and the like, as used herein do not denote any order, quantity, or importance, but rather are used to distinguish one element from another. “A combination thereof” is an open term that includes at least one of the listed elements, optionally together with one or more equivalent elements not listed.

As used herein, the term “hydrocarbyl” and “hydrocarbon” refers broadly to a substituent comprising carbon and hydrogen, optionally with 1 to 3 heteroatoms, for example, oxygen, nitrogen, halogen, silicon, sulfur, or a combination thereof; “alkyl” means a straight or branched chain, saturated monovalent hydrocarbon group; “alkylene” means a straight or branched chain, saturated, divalent hydrocarbon group; “alkylidene” means a straight or branched chain, saturated divalent hydrocarbon group, with both valences on a single common carbon atom; “alkenyl” means a straight or branched chain monovalent hydrocarbon group having at least two carbons joined by a carbon-carbon double bond; “cycloalkyl” means a non-aromatic monovalent monocyclic or multicyclic hydrocarbon group having at least three carbon atoms, “cycloalkenyl” means a non-aromatic cyclic divalent hydrocarbon group having at least three carbon atoms, with at least one degree of unsaturation; “aryl” means an aromatic monovalent group containing only carbon in the aromatic ring or rings; “arylene” means an aromatic divalent group containing only carbon in the aromatic ring or rings; “alkylarylene” means an aryl group that has been substituted with an alkyl group as defined above, with 4-methylphenylene being an exemplary alkylarylene group; “arylalkylene” means an alkyl group that has been substituted with an aryl group as defined above, with benzyl being an exemplary arylalkylene group; and the suffix “oxy” means any of the groups as defined above with the indicated number of carbon atoms attached through an oxygen bridge (—O—), with an exemplary -oxy group being an alkoxy such as methoxy.

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents and/or variables are permissible provided that the substitutions do not significantly adversely affect synthesis or use of the compound. Exemplary groups that can be present on a “substituted” position include, but are not limited to, cyano; hydroxyl; nitro; azido; alkanoyl (such as a C₂₋₆ alkanoyl group such as acyl); carboxamido; C₁₋₆ or C₁₋₃ alkyl, cycloalkyl, alkenyl, and alkynyl (including groups having at least one unsaturated linkages and from 2 to 8, or 2 to 6 carbon atoms); C₁₋₆ or C₁₋₃ alkoxy; C₆₋₁₀ aryloxy such as phenoxy; C₁₋₆ alkylthio; C₁₋₆ or C₁₋₃ alkylsulfinyl; C₁₋₆ or C₁₋₃ alkylsulfonyl; aminodi(C₁₋₆ or C₁₋₃)alkyl; C₆₋₁₂ aryl having at least one aromatic rings (e.g., phenyl, biphenyl, naphthyl, or the like, each ring either substituted or unsubstituted aromatic); C₇₋₁₉ arylalkylene having 1 to 3 separate or fused rings and from 6 to 18 ring carbon atoms; or arylalkylenoxy having 1 to 3 separate or fused rings and from 6 to 18 ring carbon atoms, with benzyloxy being an exemplary arylalkylenoxy. The number of carbon atoms in the various groups include any substituents.

While typical embodiments have been set forth for illustration, the foregoing descriptions should not be deemed to be a limitation on the scope herein. Accordingly, various modifications, adaptations, and alternatives can occur to one skilled in the art without departing from the spirit and scope herein.

1. A thermoplastic composition comprising, based on the total weight of the thermoplastic composition:
40 to 70 wt % of a polyester;
5 to 50 wt % of a poly(carbonate-siloxane) copolymer, a poly(carbonate-siloxane-arylate), or a combination thereof; and
0.1 to 8 wt % of an additive comprising a processing aid, a heat stabilizer, an antioxidant, an ultra violet light absorber, or a combination thereof,
wherein an ASTM tensile bar comprising the composition has
a tensile strength retention of at least 90% after exposure of the bar for 7 days to SANI-CLOTH AF3 at a temperature of 23° C. under 1% strain compared to a non-exposed reference tested at the same temperature, and a tensile elongation at break retention of at least 80% after exposure of the bar for 7 days to SANI-CLOTH AF3 at a temperature of 23° C. under 1% strain compared to a non-exposed reference tested at the same temperature, the tensile strength retention and tensile elongation at break retention are measured according to ASTM D 638 and compared to the non-exposed reference.

2. The thermoplastic composition of claim 1, wherein the composition comprises less than 10 wt % of polycarbonate homopolymers, based on the total weight of the thermoplastic composition.

3. The thermoplastic composition of claim 1, wherein the polyester comprises a poly(1,4-cyclohexane-dimethanol-1,4-cyclohexane dicarboxylate), a poly(ethylene terephthalate)-co-(1,4-cyclohexanedimethylene terephthalate), a polybutylene terephthalate, a polyethylene terephthalate, or a combination thereof.

4. The thermoplastic composition of claim 1, wherein the thermoplastic composition comprises the poly(carbonate-siloxane) copolymer, which comprises bisphenol A carbonate units and siloxane units of the formula 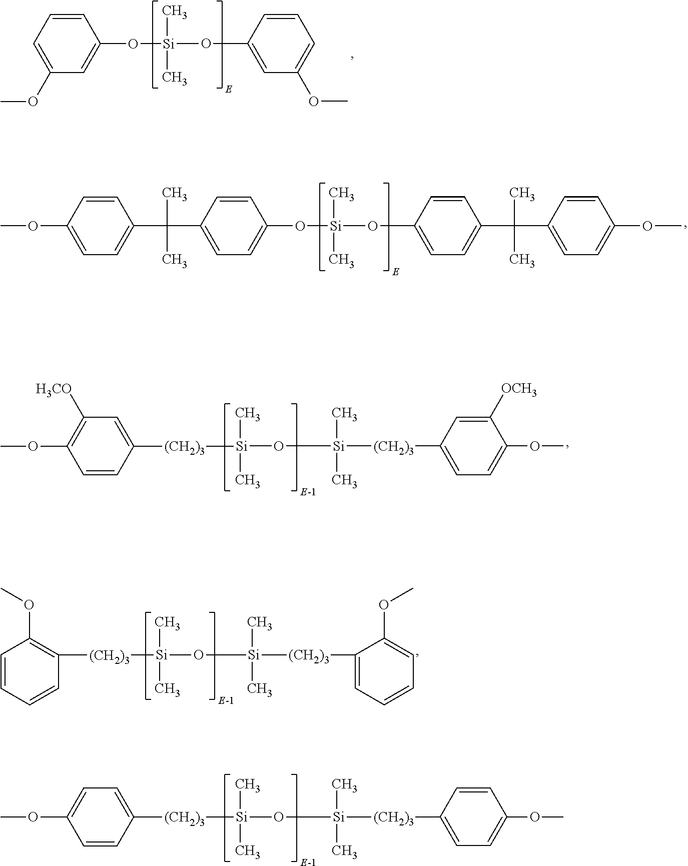
or a combination thereof, wherein E has an average value of 5 to 120.

5. The thermoplastic composition of claim 1, wherein the thermoplastic composition comprises the poly(carbonate-siloxane-arylate), which comprises
0.2 to 10 wt % siloxane units,
50 to 99.6 wt % arylate units, and
0.2 to 49.8 wt % carbonate units,
each based on the weight of the poly(carbonate-siloxane-arylate); and
the arylate units are isophthalate-terephthalate-resorcinol ester units;
the carbonate units are bisphenol A carbonate units, resorcinol carbonate units, or a combination thereof; and
the siloxane units are of the formula 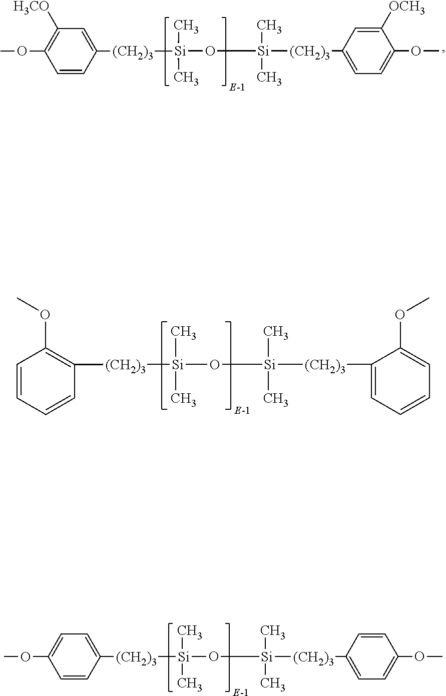
or a combination thereof, wherein E has an average value of 5 to 20.

6. The thermoplastic composition of claim 1, comprising, based on the total weight of the thermoplastic composition:
50 to 70 wt % of the polyester, which comprises a poly(1,4-cyclohexane-dimethanol-1,4-cyclohexane dicarboxylate), a poly(ethylene terephthalate)-co-(cyclohexanedimethylene terephthalate), or a combination thereof; and
30 to 50 wt % of the poly(carbonate-siloxane) copolymer, the poly(carbonate-siloxane) copolymer comprising bisphenol A carbonate units and siloxane units of the formula 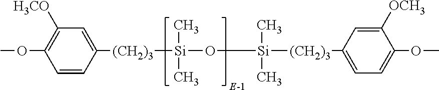
wherein E has an average value of 10 to 100, and optionally the poly(carbonate-siloxane) copolymer has a siloxane content of 10 to 30 wt % based on the total weight of the poly(carbonate-siloxane).

7. The thermoplastic composition of claim 1, comprising, based on the total weight of the thermoplastic composition:
50 to 70 wt % of the polyester, which comprises a poly(1,4-cyclohexane-dimethanol-1,4-cyclohexane dicarboxylate), a poly(ethylene terephthalate)-co-(cyclohexanedimethylene terephthalate), or a combination thereof;
5 to 50 wt % of the poly(carbonate-siloxane) copolymer; and
5 to 35 wt % of a flame retardant;
wherein the poly(carbonate-siloxane) copolymer comprises bisphenol A carbonate units and siloxane units of the formula 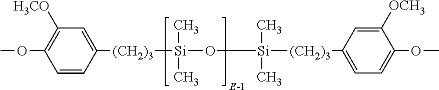
wherein E has an average value of 10 to 100, and optionally the poly(carbonate-siloxane) copolymer has a siloxane content of 10 to 30 wt % based on the total weight of the poly(carbonate-siloxane).

8. The thermoplastic composition of claim 1, comprising, based on the total weight of the thermoplastic composition:
40 to 60 wt % of the polyester which comprises a polybutylene terephthalate;
5 to 50 wt % of the poly(carbonate-siloxane) copolymer; and
5 to 35 wt % of a flame retardant;
wherein the poly(carbonate-siloxane) copolymer comprises bisphenol A carbonate units and siloxane units of the formula 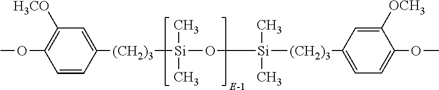
wherein E has an average value of 10 to 100, and optionally the poly(carbonate-siloxane) copolymer has a siloxane content of 10 to 30 wt % based on the total weight of the poly(carbonate-siloxane).

9. The thermoplastic composition of claim 8, further comprising, based on the total weight of the thermoplastic composition, 5 to 20 wt % of an impact modifier comprising acrylonitrile-butadiene-styrene polymer (ABS), an acrylonitrile-styrene-butyl acrylate (ASA) polymer, a methyl methacrylate-acrylonitrile-butadiene-styrene (MABS) polymer, a methyl mnethacrylate-butadiene-styrene (MBS) polymer, and an acrylonitrile-ethylene-propylene-diene-styrene (AES) polymer, or a combination thereof.

10. The thermoplastic composition of claim 8, wherein the polyester comprises a first polybutylene terephthalate with an intrinsic viscosity of 1 to 1.5 deciliter/gram (dl/g) as measured in a 60:40 phenol/tetrachloroethane mixture; and a second polybutylene terephthalate with an intrinsic viscosity of 0.9 to 0.3 dl/g as measured in a 60:40 phenol/tetrachloroethane mixture, and the weight ratio of the first polybutylene terephthalate relative to the second polybutylene terephthalate is 10:1 to 2:1.

11. The thermoplastic composition of claim 1, comprising, based on the total weight of the thermoplastic composition:
50 to 70 wt % of the polyester, which comprises a poly(1,4-cyclohexane-dimethanol-1,4-cyclohexane dicarboxylate), a poly(ethylene terephthalate)-co-(1,4-cyclohexanedimethylene terephthalate), or a combination thereof; and
30 to 50 wt % of the poly(carbonate-siloxane-arylate), which comprises, based on the weight of the poly(carbonate-siloxane-arylate):
50 to 99.6 wt % isophthalate-terephthalate-resorcinol ester units;
0.2 to 49.8 wt % of bisphenol A carbonate units; and
0.2 to 10 wt % siloxane units of the formula 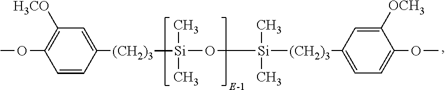
wherein E has an average value of 5 to 20.

12. The thermoplastic composition of claim 1, comprising, based on the total weight of the thermoplastic composition,
50 to 70 wt % of the polyester, which comprises a poly(1,4-cyclohexane-dimethanol-1,4-cyclohexane dicarboxylate), a poly(ethylene terephthalate)-co-(cyclohexanedimethylene terephthalate), or a combination thereof;
5 to 35 wt % of the poly(carbonate-siloxane-arylate); and
5 to 35 wt % of a flame retardant;
wherein the poly(carbonate-siloxane-arylate) comprises, based on the weight of the poly (carbonate-siloxane-arylate):
50 to 99.6 wt % isophthalate-terephthalate-resorcinol ester units;
0.2 to 49.8 wt % of bisphenol A carbonate units; and
0.2 to 10 wt % siloxane units of the formula 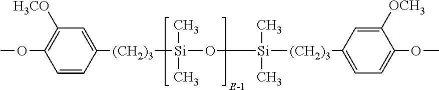
wherein E has an average value of 5 to 20.

13. The thermoplastic composition of claim 1, further comprising 0.5 to 10 wt % of an antimony compound based on the total weight of the thermoplastic composition, and optionally the antimony compound is St>203.

14. An article comprising the thermoplastic composition of claim 1.

15. The article of claim 14, wherein the article is a healthcare product or a component thereof.
